(19) United States
(12) Patent Application Publication
(10) Pub. No.: US 2003/0084308 A1
(43) Pub. Date: May 1, 2003

(54) Memory encryption

(76) Inventor: Sander Matthijs Van Rijnswou, Eindhoven (NL)

Correspondence Address: U.S. Philips Corporation, 580 White Plains Road, Tarrytown, NY, 10591, US

(21) Appl. No.: 10/261,894

(22) Filed: Sep. 30, 2002

(30) Foreign Application Priority Data
Oct. 3, 2001 (EP) 01203740.4

(51) Int. Cl. H04L 9/32; G06F 11/30

(52) U.S. Cl. 713/189

(57) ABSTRACT

An encryptor 20 encrypts a data word D under control of the associated address A using two cryptographic steps. A hash function B1 converts the address A into a hashed address B1(A). A combiner 24, such as an XOR function, combines the data word D with the hashed address B1(A). The outcome is encrypted further using a block cipher B2. A writer 30 writes the encrypted word D′ to the memory 60 under control of the address A.

A decryptor 40 decrypts an encrypted word D′ that has been read from the memory 60 under control of the associated address A. The hash function B1 converts the associated address A into a hashed address B1(A). The inverse block cipher B2⁻¹ decrypts the encrypted word D′ to an intermediate form. A decomposer, such as an XOR, produces the plaintext data word D by combining the decrypted encrypted word B2⁻¹(D′) with the hashed address B1(A).

The invention relates to encrypting/decrypting data words for secure storage in a memory, where the data words are identified by respective addresses.

Cryptography is becoming increasingly important. Main areas are content encryption/decryption and access management functions. It is important to protect the entire supply chain, including the transmission via a network or supply on a storage medium, like a CD, as well as the actual use of the content in a rendering device. This also implies that storage of the data in a solid state random access memory of a rendering device or smart card also needs to be protected. In principle, encryption based on block ciphers can be used for such protection. Cryptographically strong block ciphers encrypt more than one component (typically a component is a byte) of a word at a time. Such a word is usually referred to as a block, hence the name block cipher. For example, DES encrypts 8 bytes together, AES encrypts 16 bytes together. Even a very small block cipher might still encrypt 4 bytes in one block. Encrypting several bytes together is necessary since it makes the number of possible codebook words much larger and it flattens the statistical distribution. DES is one of the most well-known block ciphers and uses sixteen cryptographic rounds. By using DES in the ECB mode (Electronic Code Book mode) each plaintext word of eight bytes is encrypted separately giving an encrypted eight byte word.

At application level, e.g. for rendering data, many simple devices operate on one byte at a time. Using a block cipher in the conventional ECB mode has a disadvantage for such systems. A change to one of the bytes of a word results in a change to all bytes of the encrypted word. It is therefore not directly possible to change only one of the bytes of the encrypted word. It is necessary to first retrieve all other bytes of the word in plain text form. For an 8-byte block cipher, this implies that changing one of the bytes involves reading the corresponding encrypted eight byte word from the memory, decrypting the word, changing one of the eight bytes and re-encrypting the updated word. For DES this involves thirty-two time consuming cryptographic rounds. As a result, access to encrypted memory is significantly slower than access to unencrypted memory. This is particularly a problem for consumer electronics devices where price pressure makes it difficult to overcome or reduce the additional delay by means of additional hardware. Moreover, it is also desired to keep the power consumption low. Therefore, for applications requiring a fast memory access the number of rounds may need to be reduced, resulting in a weaker protection.

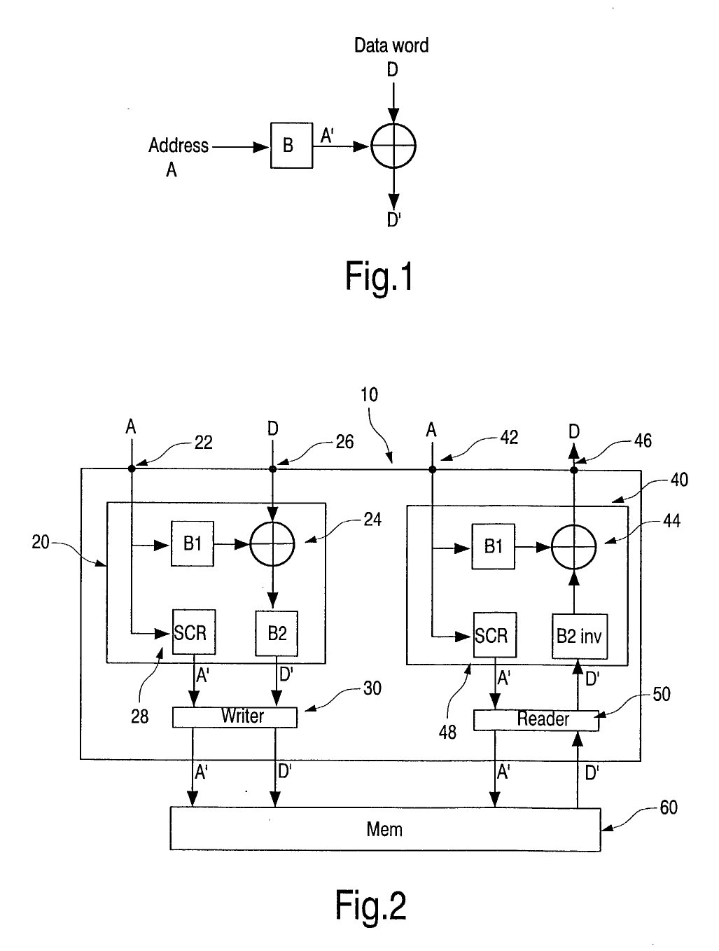

It is known to perform memory encryption using a block cipher in the so-called counter mode (CTR). This is illustrated in FIG. 1. Each word D is identified by a respective address A. The address A is encrypted using a block cipher B in ECB mode into an encrypted address A′=B(A). The data word D is combined with the encrypted address A′ to give the encrypted word D′. The combination is performed using an XOR function: D′=XOR(D, B(A)). Instead of a block cipher in ECB mode also other suitable one way functions (hash) may be used. Since the address identifies all components (such as bytes) of the word, the hashed address is valid for all components. A change of one component can be effected by recalculating the encrypted address A′=B(A), retrieving the original data word (D=XOR(D′, B(A)), changing the component of the word which gives a new plain text word D1, and recombining D1 with the encrypted address (D1′=XOR(D1, B(A)). In this scheme only one encryption step takes place (for DES, requiring 16 rounds). However, it is known that the CTR mode is cryptographically weak when it is used for encryption of random access memory. Whereas normally for a four byte word for a brute force attack a total of 256⁴ pairs of words and their encrypted counter parts need to be collected, here individual bytes can be attacked. Consequently, the system can be broken by collecting only 4*256 pairs.

It is an object of the invention to provide a memory encryption architecture that enables fast access while maintaining adequate security. It is a further object that such an architecture can be efficiently implemented in hardware and software allowing a broad use in consumer electronic applications.

To meet the object of the invention, the system includes an encryptor and decryptor as described in claim 1. A hash function is used to scramble the address and the combination of the scrambled address and data word is encrypted further using a block cipher. This last step overcomes the weakness of the CTR mode memory encryption. By using a two step encryption (address hashing and encryption of the combination), the encryption strength of the last permutation can be reduced, so that much of the speed advantage of the CTR mode can be maintained.

According to the measure of the dependent claim 2, the architecture enables a parallel arrangement of the two cryptographic steps for reading. This increases the speed of memory access. It is a further advantage that the read speed can be increased since in many systems processing may need to be halted until the data is read, whereas processing can be continued during the writing that occurs in the background.

According to the measure of the dependent claim 3, the same block cipher rounds are used for both the address hashing and the scrambling of the data with the hashed address. This has the advantage that only one cryptographic function needs to be implemented.

According to the measure of the dependent claim 4, the default number of rounds of the predetermined block cipher (e.g. DES uses 16 rounds) is divided over the hashing of the address and the encryption of the combination of the hashed addresses and the data word. As such the total number of rounds can be kept the same as used in the CTR mode of memory encryption, while increasing the cryptographic strength compared to CTR.

According to the measure of the dependent claim 5, both operations of hashing of the address and the encrypting of the combination of the hashed addresses and the data word use at least 3 rounds, ensuring a reasonable level of permutation.

In a preferred embodiment as described in the dependent claim 6 both operations use the same number of rounds. This particularly makes a parallel operation optimally fast.

According to the measure of the dependent claim 7, the architecture enables fast updating of one or more components of a word, where the entire word is not available in plain text form.

The object of the invention is also met by an encryptor and decryptor claimed in independent claims 8 and 9, respectively, and the respective methods and computer program products as claimed in the independent claims 10 to 13.

These and other aspects of the invention will be apparent from and elucidated with reference to the embodiments shown in the drawings.

FIG. 1 shows the prior art CTR memory encryption architecture; and

FIG. 2 illustrates the memory encryption architecture according to the invention.

FIG. 2 shows the cryptographic system according to the invention. The system includes a cryptographic unit 10 with an encryptor 20 and a decryptor 40. The unit 10 is typically connected to a direct access memory 60 for storing data in a secure way. It will be appreciated that with data also programs (i.e. computer instructions in any form, such as executable code) is meant. In the description it is assumed that the memory is of a read and write type. However, the system can also be used for reading only. Preferably the cryptographic unit 10 is implemented in a secure module to reduce the chance of tampering.

The encryptor 20 receives via an input 26 from a processing unit a data word D that consists of a plurality of components. Typically a component is a byte, but other sizes such as nibbles or 16-bit components may also be used. The encryptor 20 also receives an address A via the input 22 identifying the storage location(s) of the word in the memory 60. Preferably, the processing unit that supplies the word D and address A is also incorporated in the same secure module. The encryptor 20 includes a hashing function B1 for converting the address to a hashed address B1(A). Preferably, the hashing function B1 is a keyed hash function implemented in the form of rounds of a block cipher. DES or TEA are well-known and suitable ciphers to be used in the system according to the invention. The encryptor 20 also includes a combiner 24 for combining the hashed address B1(A) with the received word D. Preferably, the combiner 24 is implemented as a bit-wise XOR (exclusive OR) function. This gives an intermediate result of XOR(D, B1(A)). The output of the combiner 24 is fed through a block cipher B2 of the encryptor 20 giving the encrypted word D′. A writer 30 writes the encrypted word D′ to the memory under control of the address A. The writing may be under direct control of the address A. However, particularly if the memory 60 is outside the secure module, it is preferred that the encryptor includes an additional scrambling function 28 for scrambling the address A to a scrambled address A′ that is used for accessing the memory 60. The scrambled address A′ is then supplied to the writer 30 instead of the address A. The scrambling function should not be the same as the hash function B1 to ensure that no information leaks from the secure module. It will be appreciated that normally the address will identify the individual component of the word. A word address can usually be derived in a simple way from the component address (e.g. by ignoring the two least significant bits of a byte-level address, where there are four bytes in a word).

The decryptor 40 performs an inverse operation of the encryptor 20. Via an input 42 the decryptor 40 receives an address A from a processing unit. The decryptor optionally includes a scrambling function 48 for scrambling the address A to address A′ that is used for accessing the memory 60. The scrambling function 48 is the same as the scrambling function 28 of the encryptor 20. A reader 50 reads an encrypted word D′ from the memory 60 under control of the address A (or optionally the scrambled address A′). The encrypted word D′ is fed through a decryptor B2⁻¹ that is the inverse of B2. For many block ciphers, such as Feistel block ciphers, the rounds of the inverse cipher are the same as the rounds of the encrypting cipher, where the round keys are supplied in reverse order. The address A is fed through the same hashing function B1 as used by the encryptor 20 for converting the address into a hashed address B1(A). A decomposer 44 is used to extract the plaintext word D from the partially decrypted word B2⁻¹(D′) using the hashed address B1(A). In a preferred embodiment the XOR function 24 is mirrored in also using an XOR function for the decomposer 44. The decomposition is then: D=XOR(B2⁻¹(D′), B1(A)). D is supplied to a processing unit via an output 46.

The processing unit typically also supplies the key(s) for the cryptographic functions B1 and B2 to the encryptor/decryptor.

It will be appreciated that in a system wherein encrypting and decryption occurs time-sequential, the corresponding operations of the encryptor and decryptor need only be implemented once. In particular, it is preferred that B1 and B2 use cryptographic rounds of the same block cipher. If B2 is its own inverse (with round keys supplied in reverse order), only one round function needs to be implemented to support both the encryption and the decryption.

In a preferred embodiment, the decryptor 40 performs the inverse operation B2⁻¹ and the address hashing B1 in parallel. If B2⁻¹ and B1 are based on the same round function this does imply that such a function needs to be implemented twice, but it reduces the time required for decryption.

Preferably, the hash function B1 uses k rounds of a predetermined block cipher with a default number of n rounds (k<n) and the block cipher of the encryptor (B1) uses n−k rounds of the predetermined block cipher. In this way the n rounds are divided over the B1 operation of hashing the address and the B2 (or for reading, the B2⁻¹ operation) of encrypting the intermediate result XOR(D, B1(A)). While maintaining an adequate strength, reading can be performed fast using the described parallel arrangement. In the parallel arrangement, reading requires a time to perform max(k, n−k) rounds, while in the conventional system this takes n rounds. Particularly if n=k the parallel arrangement halves the amount of computing time and thus can also significantly reduce the power consumption (or enables raising the security by using more rounds while maintaining a similar level of power consumption)

For the hashing of the address effected by B1 and the encryption effected by B2 to be reasonably strong it is preferred that k>=3 and n−k>=3 for conventional block ciphers, such as DES, that typically use 16 rounds in total. It will be appreciated that although there are good cryptographic reasons to use at least 3 rounds with existing block ciphers, in general as many rounds should be used that ensures a reasonable level of scrambling with the particular block cipher in question.

In a preferred embodiment, the address hashing B1 and the encryption/decryption B2 use the same number of rounds (n=k). In addition to balancing the cryptographic strength over two parts, this optimizes the read speed as described above.

Using the architecture according to the invention, enables a quick updating of individual components, such as nibbles, bytes or 16 bit parts, of a larger composite word (block). As an example, assume that a word D consists of four components d₀ to d₃ and that components d₀ needs to be updated. First the address A of word D is loaded (usually provided by the processing unit). Next, the reader 50 is used to read the corresponding encrypted word D′ from a memory under control of the address A associated with the word. If the optional address scrambling is used, the address scrambler 48 is used to produce the scrambled address A′ used for accessing the memory 60. Next the hash function B1 is used to convert the address A of the word into a hashed address B1(A). The block cipher B2⁻¹ decrypts the encrypted word D′ to the intermediate form. As described earlier, for these read activities, B1 and B2⁻¹ are preferably executed in parallel. Now the ingredients (B1(A), B2⁻¹(D′), and d₀) are all available to form an updated intermediate result. This updating is performed by a component updater that combines the new component value (d₀′) with the decrypted encrypted word (B2⁻¹(D′)) under control of the hashed address (B1(A)), forming an updated combined word/hashed address. This component updater is not shown in the figures. In the preferred embodiment, the composition 24 is performed by an XOR operation. For such a system, the updating of component d₀ can be performed by extracting the least significant component from the hashed address B1(A) and combining this with the new value d₀′ using a component wide XOR function. The resulting combined component value is then loaded in the least significant component location of B2⁻¹(D′). After such a component updating has been completed, the block cipher B2 is used to encrypt the updated combined word/hashed address into an updated encrypted word. This word is then written to the memory 60 using the writer 30. If the optional address scrambling was used, the same scrambled address that initially was used to read the word can now be used again to write the updated word.

It will be appreciated that the memory encryption is preferably implemented using a dedicated encryption/decryption device. The described cryptographic operations may be implemented in dedicated hardware or performed by a cryptographic processor. The processor may be based on a conventional processor core but may also be based on a dedicated cryptographic processing core with instructions optimized for cryptographic operations. The processor is usually operated under control of a suitable program (firmware) to perform the steps of the algorithm according to the invention. It is preferred that such a computer program product is embedded in a secure way in the memory encryption system according to the invention. If desired, it may also be loaded from a background storage, such as a harddisk or ROM, where preferably the program is cryptographically protected (e.g. using DES) against malicious users. The computer program product can be stored on the background storage after having been distributed on a storage medium, like a CD-ROM, or via a network, like the public Internet. Sensitive information, like an encryption key, is preferably distributed and stored in a secure way. Techniques for doing so are generally known and not described further. The cryptographic system may, in part or in whole, be implemented on a smart-card.

1. A system for storing data words in an encrypted form in a memory, the data words being identified by respective associated addresses; the system including:
an encryptor for encrypting a data word (D) under control of the associated address (A); the encryptor including:
a hash function (B1) for converting the associated address (A) into a hashed address (B1(A)),
a combiner for combining the data word (D) with the hashed address (B1(A)), and
a block cipher (B2) for encrypting the combined word/hashed address into an encrypted word (D′);
a writer for writing the encrypted word (D′) to the memory under control of the associated address (A);
a reader for reading an encrypted word (D′) from a memory under control of an address (A) associated with the word;
a decryptor for decrypting the read encrypted word (D′) under control of the associated address (A); the decryptor including:
a hash function (B1) for converting the associated address (A) into a hashed address (B1(A)); the hash function being the same as used by the encryptor;
a block cipher (B2^{31 1}) for decrypting the encrypted word (D′); the block cipher being an inverse of the block cipher (B2) of the encryptor; and
a decomposer for retrieving a data word (D) by combining the decrypted encrypted word (B2⁻¹(D′)) with the hashed address (B1(A)).

2. A system as claimed in claim 1, wherein in the decryptor the hash function (B1) and the block cipher (B2⁻¹) are arranged in parallel.

3. A system as claimed in claim 1, wherein the hash function and the block cipher of the encryptor (B1) use rounds of a same predetermined block cipher.

4. A system as claimed in claim 3, wherein the predetermined block cipher has a default number of n rounds; the hash function uses k rounds of the predetermined block cipher, where 1<=k<n, and the block cipher of the encryptor (B1) uses n−k rounds of the predetermined block cipher.

5. A system as claimed in claim 4, wherein k>=3 and n−k>=3.

6. A system as claimed in claim 4, wherein n=k.

7. A system as claimed in claim 1, wherein the data word includes a plurality of components, the system being operative to update a component (dᵢ) of the data word (D) to a new component value by:
using the reader to read an encrypted word (D′) from a memory under control of an address (A) associated with the data word (D);
using the hash function (B1) to convert the associated address (A) into a hashed address (B1(A));
using the block cipher (B2⁻¹) of the decryptor to decrypt the encrypted word (D′);
using a component updater to combine the new component value (dᵢ) with the decrypted encrypted word (B2⁻¹(D′)) under control of the hashed address (B1(A)), forming an updated combined word/hashed address; and
using the block cipher (B2) of the encryptor for encrypting the updated combined word/hashed address into an updated encrypted word.

8. An encryptor for use in a system for storing data words in an encrypted form in a memory as claimed in claim 1 wherein each data word is identified by a respective associated address; the encryptor including:
a hash function (B1) for converting an address (A) associated with a data word (D) into a hashed address (B1(A)),
a combiner for combining the data word (D) with the hashed address (B1(A)), and
a block cipher (B2) for encrypting the combined word/hashed address into an encrypted word (D′).

9. A decryptor for use in a system wherein data words are stored in an encrypted form in a memory as claimed in claim 1; wherein each data word is identified by a respective associated address; the decryptor including:
a hash function (B1) for converting an address (A) associated with a data word in the memory into a hashed address (B1(A));
a block cipher (B2⁻¹) for decrypting an encrypted word (D′) that has been read from the memory under control of the associated address (A); and
a decomposer for retrieving a plaintext data word (D) by combining the decrypted encrypted word (B2⁻¹(D′)) with the hashed address (B1(A)).

10. A method of encrypting data words for storage in a memory in an encrypted form, wherein each data word is identified by a respective associated address; the method including:
converting an address (A) associated with a data word (D) into a hashed address (B1(A)),
combining the data word (D) with the hashed address (B1(A)), and
using a block cipher (B2) to encrypt the combined word/hashed address into an encrypted word (D′) for subsequent storage in the memory.

11. A method of decrypting data words stored in a memory in an encrypted form, wherein each data word is identified by a respective associated address; the method including:
converting an address (A) associated with an encrypted data word (D′) stored in the memory into a hashed address (B1(A));
using a block cipher (B2⁻¹) to decrypt the encrypted data word (D′) read from the memory under control of the associated address(A) to an intermediate form (B2⁻¹(D′)); and
retrieving a plaintext data word (D) by combining the intermediate form (B2⁻¹(D′)) with the hashed address (B1(A)).

12. A computer program product where the program product is operative to cause a processor to perform the method of claim 10.

13. A computer program product where the program product is operative to cause a processor to perform the method of claim 11.
